(19) United States
(12) Patent Application Publication
(10) Pub. No.: US 2025/0222466 A1
(43) Pub. Date: Jul. 10, 2025

(54) ELECTRIC DUST COLLECTION DEVICE, AND CHARGING DEVICE INCLUDED IN ELECTRIC DUST COLLECTION DEVICE

(71) Applicant: SAMSUNG ELECTRONICS CO., LTD., Suwon-si (KR)

(72) Inventors: Daisuke FUKUOKA, Yokohama-shi (KR); Kazutoshi TAKENOSHITA, Yokohama-shi (JP); Kahoru TSUJIMOTO, Yokohama-shi (JP)

(73) Assignee: SAMSUNG ELECTRONICS CO., LTD., Suwon-si (KR)

(21) Appl. No.: 19/092,568

(22) Filed: Mar. 27, 2025

Related U.S. Application Data
(63) Continuation of application No. PCT/KR2023/008938, filed on Jun. 27, 2023.

(30) Foreign Application Priority Data
Dec. 7, 2022 (JP) 2022-195702

(51) Int. Cl. B03C 3/38; B03C 3/08; B03C 3/41

(52) U.S. Cl. CPC B03C 3/38; B03C 3/08; B03C 3/41; B03C 2201/08

(57) ABSTRACT

An electric dust collection device including a charging unit configured to charge airborne particulate matter, a dust collection unit configured to collect dust by attaching the particulate matter charged by the charging unit, a fan configured to generate airflow in a direction from the charging unit to the dust collection unit, and a power source configured to apply a first voltage to the charging unit, wherein the charging unit includes a discharge electrode installed approximately perpendicular to the process airflow in a first direction and configured to generate ions, a ground electrode installed in a second direction to cross the airflow, and a gradient potential electrode arranged in the first direction to allow the airflow to pass therethrough and to which a second voltage lower than the first voltage is applied, wherein the second voltage gradually decreases from the discharge electrode toward a central portion of the charging unit.

### CROSS-REFERENCE TO RELATED APPLICATIONS

This application is a continuation of International Application No. PCT/KR2023/008938, filed Jun. 27, 2023, and claims foreign priority to Japanese Application No. 2022-195702, filed Dec. 7, 2022, which are incorporated herein by reference in their entireties.

### TECHNICAL FIELD

The present disclosure relates to an electric dust collection device and a charging device included in the electric dust collection device.

### BACKGROUND ART

Patent Document 1 discloses a corona discharge unit in which carbon fibers are fixedly retained in a retention member so as to protrude from the retention member, the protruding portion serves as a discharge unit, a terminal unit connected thereto is provided to form a corona discharge electrode, the corona discharge electrode and an opposite electrode are insulated from each other at a certain interval and then arranged to face each other to form a corona electrode system, a high voltage power source for corona discharge is provided to supply a high voltage between the terminal unit of the corona discharge electrode and the terminal unit between the opposite electrodes, and corona discharge is generated from an end of the discharge unit of the corona discharge electrode toward the opposite electrode.

Patent Document 2 discloses a charging device for airborne electric dust collection, which includes a frame, conductive microfibers arranged in the frame and configured to generate ions in the air, and conductive plates arranged in the frame and configured to generate a potential difference with the conductive microfibers, wherein the conductive plates include a first conductive plate and a second conductive plate perpendicular to each other to determine a charging space where an electric field is generated, the charging space has a rectangular pillar shape and surrounds the conductive microfibers.
Patent Document 1: Japanese Patent Application Laid-Open No. 8-112549
Patent Document 2: U.S. Pat. No. 11,161,395 Specification

### DISCLOSURE OF INVENTION

### Solution to Problem

An electric dust collection device according to the present disclosure may include a charging unit configured to charge airborne particulate matter, a dust collection unit configured to collect dust by attaching the particulate matter charged by the charging unit, a fan configured to generate airflow in a direction from the charging unit to the dust collection unit, and a power source configured to apply a first voltage to the charging unit, wherein the charging unit includes a discharge electrode arranged so as to be approximately perpendicular to the airflow in a first direction and configured to generate ions, a ground electrode arranged so as to be in a second direction to cross the airflow, and a gradient potential electrode arranged so as to be in the first direction to allow the airflow to pass therethrough and to which a second voltage lower than the first voltage and that gradually decreases from the discharge electrode toward a central portion of the charging unit is applicable.

A charging unit configured to charge airborne particulate matter and arrangeable in an electric dust collection device that includes a dust collection unit configured to collect dust by attaching the particulate matter charged by the charging unit, a fan configured to generate airflow in a direction from the charging unit to the dust collection unit, and a power source configured to apply a first voltage to the charging unit, according to the present disclosure, may include a discharge electrode arranged so as to be approximately perpendicular to the airflow in a first direction and configured to generate ions, a ground electrode arranged so as to be in a second direction to cross the airflow, and a gradient potential electrode arranged so as to be in the first direction to allow the airflow to pass therethrough and to which a second voltage lower than the first voltage and that gradually decreases from the discharge electrode toward a central portion of the charging unit is applicable.

### BRIEF DESCRIPTION OF DRAWINGS

FIG. 1 is a perspective view illustrating an example of an overall configuration of an electric dust collection device in the present embodiment.

FIG. 2 is a perspective view of a charging unit when viewed from a viewpoint (V) in FIG. 1.

FIG. 3A is a diagram illustrating an effect obtained when a charging unit forms a gradient potential in a comparative example.

FIG. 3B is a diagram illustrating an effect obtained when a charging unit forms a gradient potential in the present embodiment.

FIG. 4 is a graph showing a comparison between a voltage applied by a charging unit of Example 1 and voltages applied by charging units of Comparative Examples 1 and 2.

FIG. 5 is a cross-sectional view of the charging unit of Example 2.

FIG. 6 is a cross-sectional view of a mock-up for gradient potential verification.

FIG. 7 is a diagram illustrating a gradient potential map measured by using a mock-up for gradient potential verification.

FIG. 8 is a graph showing a relationship between a distance from an end of a discharge electrode and a potential measured at the distance.

FIG. 9 is a graph showing a relationship between a thickness of the charging unit and dust collection efficiency in the charging unit of Example 2.

FIG. 10 is a graph showing a relationship between a thickness of the charging unit and an ozone concentration in the charging unit of Example 2.

### MODE FOR THE INVENTION

Hereinafter, embodiments will be described in detail with reference to the accompanying drawings.

### Background and Overview of the Present Embodiment

Dust collection technology used in air purifiers mainly uses filtration filters, such as high efficiency particulate air (HEPA) filters. However, because regular replacement is required, dust collection technology that replaces HEPA filters is preferable so as to reduce an environmental load. As alternative technology, there is an electric dust collection device that collects dust by charging airborne particulate matter through electric discharge or the like. The electric dust collection device includes a charging unit that charges particulate matter through electric discharge and a dust collection unit that collects the charged particulate matter. Because the purification ability is maintained by regular cleaning, replacement is not required. In addition, because pressure loss of the electric dust collection device is lower than pressure loss of the HEPA filter, a load on a fan is also reduced.

The charging unit of the electric dust collection device generates electric discharge by applying a high voltage of several kilovolts (kV) between a high voltage electrode (a discharge electrode) and an opposite ground electrode and charges particulate matter with ions generated by the electric discharge. Wires or needles are common as the high voltage electrode used in the charging unit for the electric dust collection. However, to improve charging efficiency, it is necessary to increase a current value between the high voltage electrode and the ground electrode. In this case, an amount of ozone generated increases to give off a unique, irritating odor. Accordingly, ozone should not be released indoors as it is, and it is necessary to remove ozone by using activated carbon included in a deodorizing filter installed at the rear. In this case, because a load on the deodorizing filter increases, a charging unit with a structure that hardly generates ozone in the first place is required. One alternative is a charging unit in which a fibrous conductor, such as carbon, is used as a high voltage electrode. Because a starting point of the electric discharge is very small, ozone is hardly generated. However, in addition to field charging, diffusion charging is used as electric charging, and thus, it is difficult to narrow a charging space, as described above. To solve this problem, a method of providing a separation distance between a charging unit and a dust collection unit and a method of separating a charging unit from a dust collection unit and performing diffusion charging in an indoor space may be commonly used. In the former method, a thickness of a dust collection unit increases, as compared to an air purifier including HEPA filters, and thus, the size of the air purifier itself increases. The latter method may suppress a unit size, but causes a static electricity problem due to charge-up in a surrounding space.

Some electrical appliances, such as air purifiers or air conditioners, include an electric dust collection device that collects airborne particulate matter by charging the airborne particulate matter through electric discharge or the like. The electric dust collection device includes a charging unit that charges particulate matter through electric discharge and a dust collection unit that collects the charged particulate matter. The charging unit generates electric discharge by applying a high voltage of several kV between a high voltage electrode (a discharge electrode) and an opposite ground electrode and charges particulate matter with ions generated by the electric discharge.

In the case of adopting a configuration in which gradient potential electrodes are not installed on the upstream side and the downstream side of the discharge electrode and the ground electrode in the airflow, ions generated by the discharge electrode may not be transported widely, and thus, the charging space may not be uniformly charged.

The purpose of the present disclosure is to uniformly charge a charging space by widely transporting ions generated by a discharge electrode.

Therefore, the present embodiment provides a particulate matter charging device using a gradient potential electrode and an electric dust collection device using the particulate matter charging device as technology that satisfies ozone minimization, size reduction of a charging unit, and long-term stabilization of charging performance in a structure in which the charging unit and the dust collection unit are integrated.

### [Configuration of Electric Dust Collection Device in the Present Embodiment]

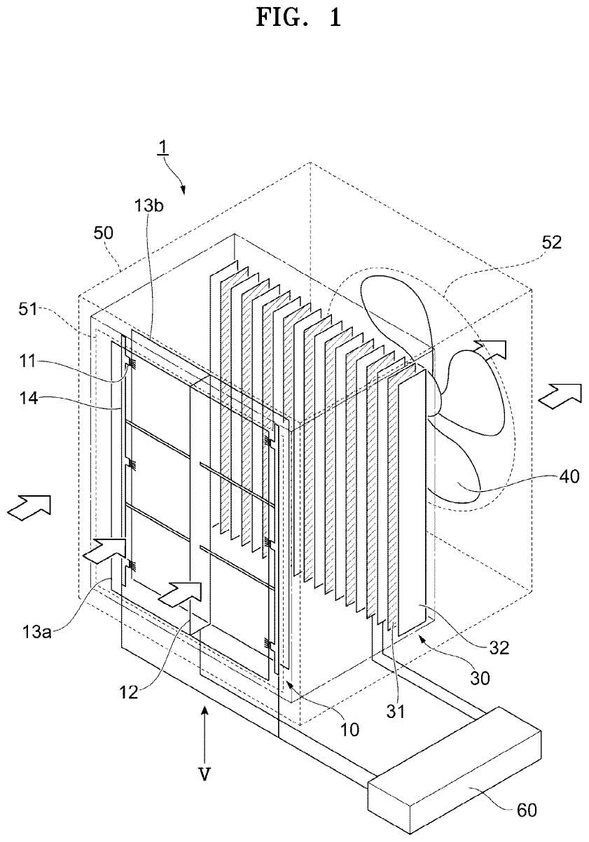

FIG. 1 is a perspective view illustrating an example of an overall configuration of an electric dust collection device 1 in the present embodiment.

As illustrated, the electric dust collection device 1 includes a charging unit 10, a dust collection unit 30, a fan 40, a case 50 that accommodates the charging unit 10, the dust collection unit 30, and the fan 40, and a high voltage power source 60 that supplies a high voltage to the charging unit 10 and the dust collection unit 30. Here, the case 50 is indicated by a dashed line, and the configuration of the charging unit 10 and the dust collection unit 30 installed in the case 50 is visible. The electric dust collection device 1 is a two-stage electric dust collection device in which the functions of the charging unit 10 and the dust collection unit 30 are separated from each other. Here, the charging unit 10 and the dust collection unit 30 may be configured in the form of detachable units.

Here, a direction (a ventilation direction) of airflow (ventilation) is set as a direction from the charging unit 10 to the dust collection unit 30, as indicated by an arrow. The ventilation is performed by the fan 40 installed on the downstream side of the ventilation direction of the dust collection unit 30.

The charging unit 10 charges airborne particulate matter. The charging unit 10 is an example of a charging device. The charging unit 10 includes a plurality of discharge electrodes 11, a ground electrode 12, gradient potential electrodes 13a and 13b, and a power supply member 14 that supplies the supplied high voltage to the plurality of discharge electrodes 11. The discharge electrode 11, the ground electrode 12, and the gradient potential electrodes 13a and 13b are described in detail below.

The dust collection unit 30 collects dust by attaching airborne particulate matter charged by the charging unit 10. For example, the dust collection unit 30 includes a dust collection filter. The dust collection unit 30 include a plate-shaped high voltage electrode 31, the surface of which is coated with an insulating material film, and a plate-shaped opposite electrode 32 having conductivity, wherein the high voltage electrode 31 and the opposite electrode 32 are alternately stacked. In addition, the opposite electrode 32 may be of a type that releases electric charges of charged particles, and may be coated with a conductive resin film or the like. The ventilation direction is a direction between the high voltage electrode 31 and the opposite electrode 32. The opposite electrode 32 is also referred to as a ground electrode because the opposite electrode 32 is sometimes grounded (GND).

In addition, polyethylene, polyethylene terephthalate (PET), polytetrafluoroethylene (PTFE), etc. may be used as the insulating material film that covers the surface of the high voltage electrode 31.

In the case 50, an inlet 51 is installed on the charging unit 10 side of the windward side (upstream side) of the ventilation direction, and an outlet 52 is installed on the dust collection unit 30 side of the leeward side. In addition, a mesh, a grid, etc. may be installed at the inlet 51. It is desirable that the mesh, the grid, etc. installed at the inlet 51 is installed so as to provide low resistance to ventilation while preventing contact of a user with the charging unit 10. In addition, a pre-filter may be installed at the inlet 51 so as to prevent infiltration of large particles.

Furthermore, the case 50 includes a resin material, such as, for example, acrylonitrile butadiene styrene (ABS) copolymer.

The fan 40 is installed at the outlet 52 of the leeward side installed in the case 50. The airflow (ventilation) enters the inlet 51 of the case 50 on the charging unit 10 side, passes through the charging unit 10 and the dust collection unit 30, and exits through the outlet 52 of the case 50 where the fan 40 is installed.

In addition, the electric dust collection device 1 may be placed in any direction as long as ventilation is not obstructed.

The high voltage power source 60 may generate corona discharge (electric discharge) between the discharge electrode 11 and the ground electrode 12 by applying a direct current (DC) high voltage between the discharge electrode 11 and the ground electrode 12. As ions generated by the generated corona discharge are attached to the particulate matter, the particulate matter may be charged. In addition, the high voltage power source 60 that applies a high voltage between the discharge electrode 11 and the ground electrode 12 may be understood as a portion of the charging unit 10.

The high voltage power source 60 also applies a DC high voltage between the high voltage electrode 31 and the opposite electrode 32. The particulate matter charged by the charging unit 10 is attached to the surface of the opposite electrode 32 by an electrostatic force. In this manner, the particulate matter is collected. In addition, the high voltage power source 60 that applies a high voltage between the high voltage electrode 31 and the opposite electrode 32 may be understood as a portion of the dust collection unit 30.

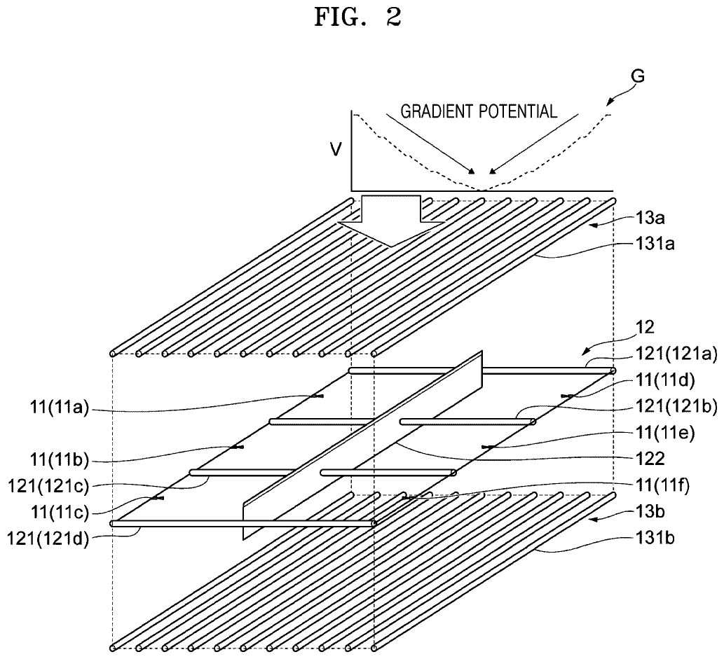

FIG. 2 is a perspective view of the charging unit 10 when viewed from a viewpoint V in FIG. 1. Accordingly, in FIG. 2, the ventilation direction is set from top to bottom, as indicated by an arrow.

As illustrated, the charging unit 10 includes a discharge electrode 11, a ground electrode 12, and gradient potential electrodes 13a and 13b.

The discharge electrode 11 generates ions through electric discharge in the air containing particulate matter, such as PM 2.5. An ion generation electrode is an example of the discharge electrode 11. As a representative configuration example, the discharge electrode 11 is formed of a plurality of fibrous conductors. The fibrous conductor may be, for example, a fibrous conductor in which carbon fibers having a fiber length of about 5 μm to 7 μm are fixed in bundles.

In addition, the discharge electrode 11 is arranged in a direction perpendicular to the airflow. However, the discharge electrode 11 does not have to be exactly perpendicular to the airflow, but may be approximately perpendicular to the airflow.

In addition, because the discharge electrode 11 is an electrode to which a high voltage is applied, the discharge electrode 11 is also referred to as a high voltage electrode. Six discharge electrodes 11a to 11f are illustrated as the plurality of discharge electrodes 11, but the number of discharge electrodes 11 is not limited thereto.

The ground electrode 12 is grounded (GND) and installed in a direction crossing the airflow so as to form a barrier that separates the plurality of discharge electrodes 11 from each other. The barrier ground electrode is an example of the ground electrode 12.

The ground electrode 12 includes an electrode unit 121 arranged at a position adjacent to the discharge electrode 11 and an electrode unit 122 arranged at a position opposite to the discharge electrode 11. The electrode unit 121 is an example of a first electrode unit, and the electrode unit 122 is an example of a second electrode unit. The electrode unit 121 and the electrode unit 122 may be formed of a conductive member having a plate shape or a rod shape (for example, a round rod shape), but it is preferable that the electrode unit 121 is formed of a conductive member having a rod shape and the electrode unit 122 is formed of a conductive member having a plate shape. Here, the electrode unit 121 is arranged in a direction perpendicular to the airflow. However, the electrode unit 121 does not have to be exactly perpendicular to the airflow, but may be approximately perpendicular to the airflow. In addition, the electrode unit 122 is installed in a direction in which a flat surface having a plate shape follows the ventilation direction. In FIG. 2, the flat plane of the electrode unit 122 is aligned with the ventilation direction (an angle formed by the flat plane of the electrode unit 122 and the ventilation direction is 0°), but the flat plane of the electrode unit 122 does not necessarily have to be aligned with the ventilation direction. In addition, the electrode unit 121 and the electrode unit 122 may be arranged to vertically cross each other. However, the electrode unit 121 does not have to be exactly perpendicular to the electrode unit 122, but may be approximately perpendicular to the electrode unit 122.

In addition, the ground electrode 12 is also referred to as the opposite electrode because the electrode unit 121 is installed to face the discharge electrode 11. Four electrode units 121a to 121d are illustrated as a plurality of electrode units 121 and one electrode unit 122 is illustrated as the electrode unit 122, but the number of electrode units 121 and electrode units 122 is not limited thereto.

Here, when only the electrode unit 121 is installed, dust collection efficiency is reduced because no conductor is installed at a position opposite to the discharge electrode 11. In addition, when only the electrode unit 122 is installed, dust collection efficiency is reduced due to field interference between the adjacent discharge electrodes 11. Therefore, it is preferable to install the ground electrode 12 so that the electrode unit 121 and the electrode unit 122 are perpendicular to each other.

The gradient potential electrodes 13a and 13b are arranged in a direction perpendicular to the airflow. However, the gradient potential electrodes 13a and 13b do not have to be exactly perpendicular to the airflow, but may be approximately perpendicular to the airflow. The gradient potential electrode 13a is installed on the upstream side of the discharge electrode 11 and the ground electrode 12 in the airflow, and the gradient potential electrode 13b is installed on the downstream side of the discharge electrode 11 and the ground electrode 12 in the airflow. In addition, the gradient potential electrodes 13a and 13b have a shape and structure in which the passing of the airflow is possible, and are installed to allow the airflow to pass therethrough. The gradient potential electrodes 13a and 13b are illustrated as respectively including a plurality of rod-shaped electrodes 131a and 131b installed approximately perpendicular to the discharge electrode 11 when projected onto a plane perpendicular to the airflow, including the discharge electrode 11. The rod-shaped electrodes 131a and 131b are an example of the first rod-shaped electrodes.

In addition, as shown in a graph G, a voltage lower than a voltage applied to the discharge electrode 11 is applied to the gradient potential electrodes 13a and 13b stepwise from the discharge electrode 11 side toward the central portion of the charging unit 10 and is grounded at the central portion. The ground electrode 12 and the gradient potential electrodes 13a and 13b are illustrated separately for easy viewing, but the electrode unit 122 of the ground electrode 12 and the gradient potential electrodes 13a and 13b may be brought into contact with each other so that the central portions of the gradient potential electrodes 13a and 13b are grounded.

### [Effect of Charging Unit in the Present Embodiment]

An effect obtained when the charging unit 10 forms a gradient potential in the present embodiment is described through a comparison with an effect obtained when the charging unit 20 forms a gradient potential in a comparative example.

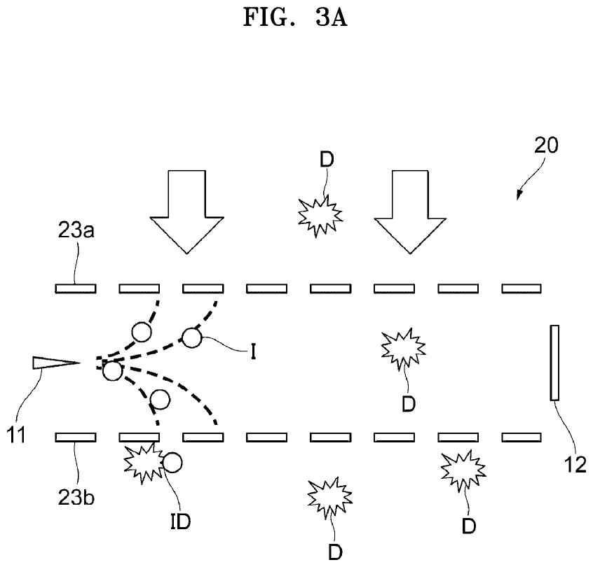

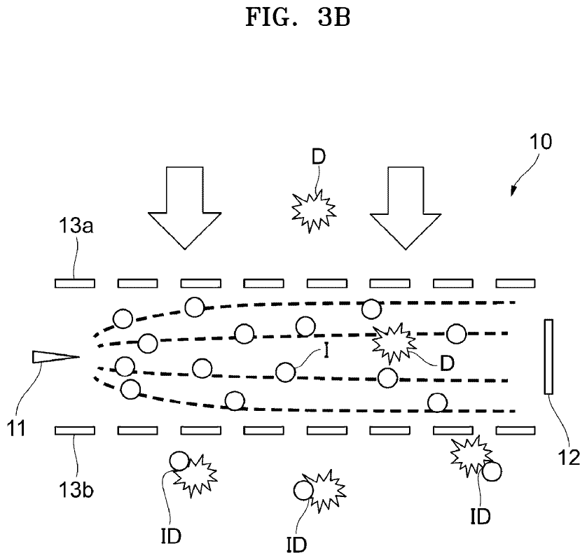

FIG. 3A is a diagram illustrating the effect obtained when the charging unit 20 forms a gradient potential in the comparative example. In the charging unit 20, constant potential electrodes 23a and 23b are respectively installed on the upstream side and the downstream side of the discharge electrode 11 and the ground electrode 12 in the airflow. In this case, a non-uniform electric field is generated in the charging space and, as illustrated, ions I generated by the discharge electrode 11 do not spread widely, and thus, the amount of generated ions I does not increase. As a result, the proportion of dust ID with the ions I attached thereto among the dust D decreases, which reduces a dust collection effect.

FIG. 3B is a diagram illustrating the effect obtained when the charging unit 10 forms a gradient potential in the present embodiment. In the charging unit 10, gradient potential electrodes 13a and 13b are respectively installed on the upstream side and the downstream side of the discharge electrode 11 and the ground electrode 12 in the airflow. In this case, a non-uniform electric field is generated in the charging space and, as illustrated, ions I generated by the discharge electrode 11 spread widely, and thus, the amount of generated ions I increases. As a result, the proportion of dust ID with the ions I attached thereto among the dust D increases, which increases a dust collection effect.

However, in the present embodiment, there are the following two methods of forming a gradient potential in the gradient potential electrodes 13a and 13b.

A first method is a method in which the plurality of rod-shaped electrodes 131a and 131b respectively constituting the gradient potential electrodes 13a and 13b are formed of a conductive member. In this case, in the first method, a voltage that decreases according to the number of rod-shaped electrodes 131a and 131b from the discharge electrode 11 side is applied to the plurality of rod-shaped electrodes 131a and 131b. In addition, as a power source for applying a voltage to the rod-shaped electrodes 131a and 131b, the high voltage power source 60 may be used, although a connection line is not illustrated in FIG. 1. In that case, a resistance greater than a resistance of a connection line between the high voltage power source 60 and the discharge electrode 11 may be provided in a connection line between the high voltage power source 60 and the rod-shaped electrodes 131a and 131b. Alternatively, as a power source for applying a voltage to the rod-shaped electrodes 131a and 131b, another power source that applies a voltage lower than a voltage applied by the high voltage power source 60 may be used, although not illustrated in FIG. 1.

A second method is a method in which the plurality of rod-shaped electrodes 131a and 131b respectively constituting the gradient potential electrodes 13a and 13b are formed of an anti-conductive member or an insulating member. In this case, in the second method, a voltage that decreases according to a distance from the discharge electrode 11 side is generated to the plurality of rod-shaped electrodes 131a and 131b by, for example, static electricity. In addition, in the second method, the gradient potential electrodes 13a and 13b may respectively include the rod-shaped electrodes 131a and 131b installed approximately parallel to the discharge electrode 11 when projected onto a plane perpendicular to the airflow, including the discharge electrode 11. That is, the gradient potential electrodes 13a and 13b may have a mesh shape. Therefore, in the second method, an electrode with the discharge electrode 11 and the ground electrode 12 inserted thereinto is also referred to as a mesh electrode. However, the rod-shaped electrodes 131a and 131b further included in the second method are not limited to being installed approximately parallel to the discharge electrode 11, and may be installed to form a certain angle greater than 0° with respect to the discharge electrode 11. That is, the gradient potential electrodes 13a and 13b may each have a mesh shape including a diamond-shaped grid, such as expanded metal or punched metal. In other words, the gradient potential electrodes 13a and 13b may further include rod-shaped electrodes 131a and 131b crossing the rod-shaped electrodes 131a and 131b illustrated in FIG. 2, respectively. The rod-shaped electrodes 131a and 131b further included in the second method are an example of second rod-shaped electrodes.

A case where the first method is used is referred to as Example 1, a case where the second method is used is referred to as Example 2, and the effect of each example is described below.

### Effect of Charging Unit of Example 1

First, a result of confirming an effect obtained when the charging unit 10 of Example 1 forms a gradient potential is described.

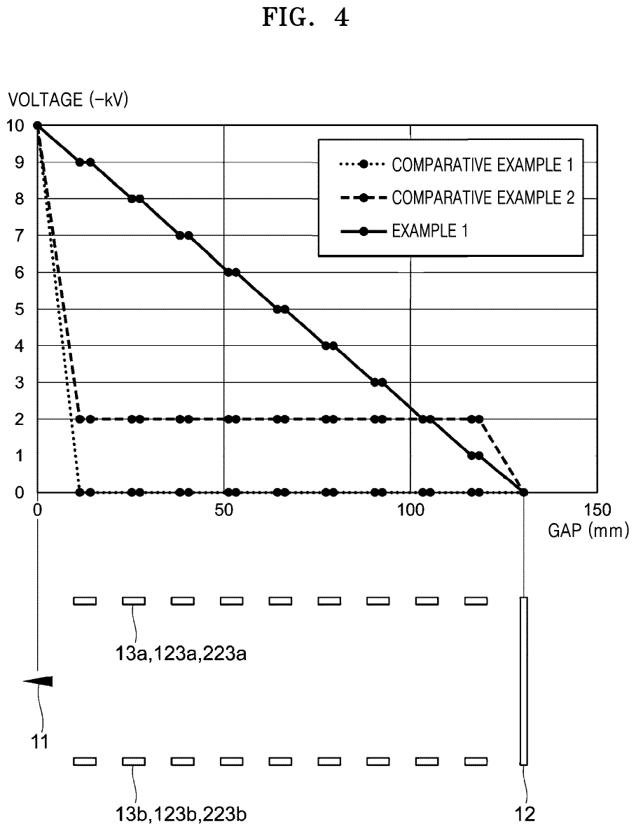

FIG. 4 is a graph showing a comparison between a voltage applied by the charging unit 10 of Example 1 and voltages applied by the charging units of Comparative Examples 1 and 2. The horizontal axis represents the gap from the discharge electrode 11. The vertical axis represents the voltage applied to the discharge electrode 11, as indicated correspondingly below the graph, when the gap from the discharge electrode 11 is 0. In addition, when the gap from the discharge electrode 11 is greater than 0, the vertical axis represents the voltage applied to each rod-shaped electrode constituting the gradient potential electrodes 13a and 13b or the constant potential electrodes, as indicated correspondingly below the graph.

In Comparative Example 1, constant potential electrodes 123a and 123b (corresponding to the constant potential electrodes 23a and 23b of FIG. 3A) are installed on the upstream side and the downstream side of the discharge electrode 11 and the ground electrode 12 in the airflow. Here, the constant potential electrodes 123a and 123b are grounded and the potentials thereof are assumed to be 0 kV. Therefore, the voltages applied to the constant potential electrodes 123a and 123b are indicated by dashed lines in the graph.

In Comparative Example 2, constant potential electrodes 223a and 223b (corresponding to the constant potential electrodes 23a and 23b of FIG. 3A) are installed on the upstream side and the downstream side of the discharge electrode 11 and the ground electrode 12 in the airflow. Here, the constant potential electrodes 223a and 223b are grounded and the potentials thereof are assumed to be −2 kV. Therefore, the voltages applied to the constant potential electrodes 223a and 223b are indicated by broken lines in the graph.

In Example 1, gradient potential electrodes 13a and 13b are respectively installed on the upstream side and the downstream side of the discharge electrode 11 and the ground electrode 12 in the airflow. Here, −9 kV to −1 kV are applied stepwise to the gradient potential electrodes 13a and 13b. Therefore, the voltages applied to the gradient potential electrodes 13a and 13b are indicated by solid lines in the graph.

The potentials of Comparative Example 1, Comparative Example 2, and Example 1 may be summarized as shown in Table 1 below.

TABLE 1

| | |
|---|---|
| Comparative | Potential is maintained at constant value (0 kV) on |
| Example 1 | upstream side and downstream side of electrode. |
| Comparative | Potential is maintained at constant value (−2 kV) |
| Example 2 | on upstream side and downstream side of electrode. |
| Comparative | Gradient potential electrode that changes stepwise |
| Example 3 | according to position from upstream side to |
| | downstream side of electrode (gradually changing |
| | from −9 kV to −1 kV) |

Next, a result of examining whether performance is able to be ensured in the charging unit 10 of Example 1.

It was confirmed that an electric field distribution was more widespread and more uniform in Example 1 than in Comparative Examples 1 and 2.

It was confirmed that a field charging contribution rate, which is a ratio of particles charged by field charging to particles charged in the charging unit, was higher in Example 1 than in Comparative Examples 1 and 2.

The thinning of the charging unit is impossible because the electric field does not reach the ground electrode 12 in Comparative Examples 1 and 2. On the other hand, in Example 1, a diffusion charging contribution rate, which is a ratio of particles charged by diffusion charging to particles charged in the charging unit 10, is reduced by the effect of thinning, but this is covered by the field charging contribution rate. That is, because the electric field is supplemented, the thinning of the charging unit 10 is possible.

### Effect of Charging Unit of Example 2

First, a result of confirming an effect obtained when the charging unit 10 of Example 2 forms a gradient potential is described.

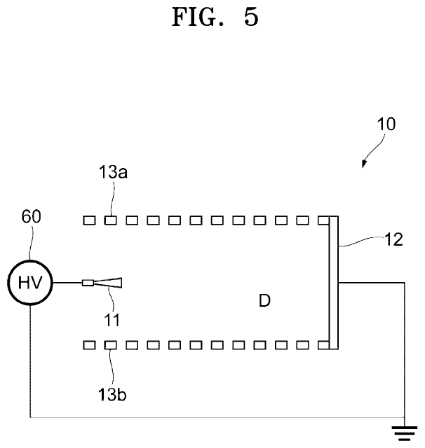

FIG. 5 is a cross-sectional view of the charging unit 10 of Example 2. The charging unit 10 includes a discharge electrode 11, a ground electrode 12, and gradient potential electrodes 13a and 13b. A high voltage power source 60 may generate electric discharge between the discharge electrode 11 and the ground electrode 12 by applying a high voltage between the discharge electrode 11 and the ground electrode 12.

In the charging unit 10, the discharge electrode 11 generates electric discharge, and thus, a gradient potential is generated by static electricity on the surfaces of the gradient potential electrodes 13a and 13b that are, for example, alumite meshes. However, it is difficult to measure the gradient potential in the charging unit 10 of FIG. 5. Accordingly, in the present embodiment, a mock-up for gradient potential verification was prepared.

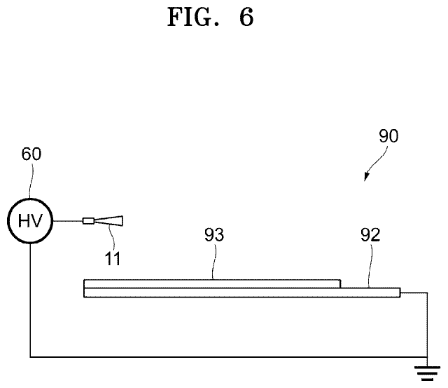

FIG. 6 is a cross-sectional view of a mock-up 90 for gradient potential verification. As illustrated, the mock-up 90 for gradient potential verification includes a discharge electrode 11, an aluminum plate 92, and alumite 93. That is, in FIG. 6, instead of the alumite mesh of FIG. 5, the grounded aluminum plate 92 processed with the alumite 93 was used. A high voltage power source 60 may generate electric discharge between the discharge electrode 11 and the aluminum plate 92 by applying a high voltage between the discharge electrode 11 and the aluminum plate 92.

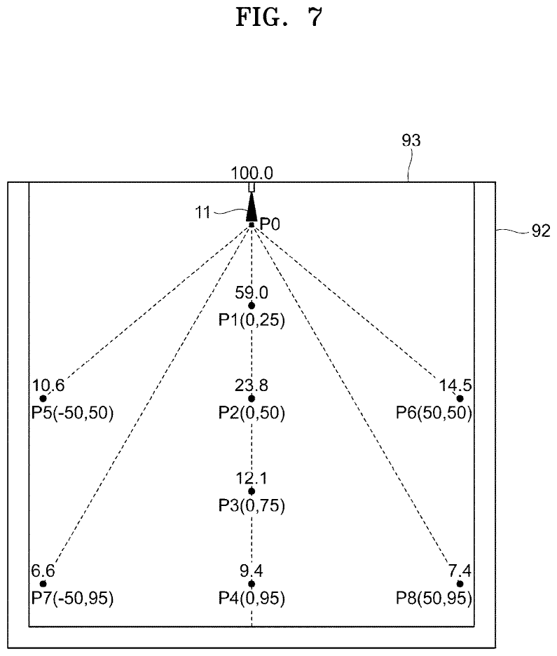

FIG. 7 is a diagram illustrating a gradient potential map measured by using the mock-up 90 for gradient potential verification. FIG. 7 shows a gradient potential map when a portion including the discharge electrode 11, the aluminum plate 92, and the alumite 93 of the mock-up 90 for gradient potential verification of FIG. 6 is viewed from above. In addition, the potential in the gradient potential map is an average potential 5 minutes to 10 minutes after electric discharge is initiated by the discharge electrode 11.

In the alumite 93, a point P0 was set at a position corresponding to the end of the discharge electrode 11, and points P1, P2, P3, and P4 were respectively set at positions of distances 25, 50, 75, and 95 from the point P0 in a downward direction of the drawing. In addition, a point P5 was set at a position of a distance 50 from the point P2 in a left direction of the drawing, and a point P6 was set at a position of a distance 50 from the point P2 in a right direction of the drawing. In addition, a point P7 was set at a position of a distance 50 from the point P4 in a left direction of the drawing, and a point P8 was set at a position of a distance 50 from the point P4 in a right direction of the drawing. The potentials at these points were measured.

When the voltage applied to the discharge electrode 11 was set to 100, the potentials of the points P1, P2, P3, P4, P5, P6, P7, and P8 were respectively 59.0, 23.8, 12.1, 9.4, 10.6, 14.5, 6.6, and 7.4.

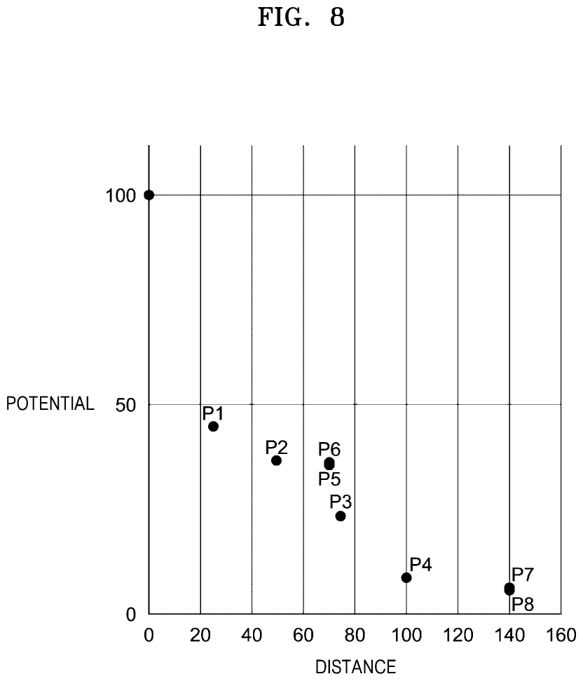

FIG. 8 is a graph showing a relationship between a distance from the end of a discharge electrode and a potential measured at the distance. The horizontal axis represents the distance from the discharge electrode 11. The vertical axis represents the potential of the discharge electrode 11 when the distance from the end of the discharge electrode 11 is 0. In addition, the vertical axis represents the potential in the gradient potential map when the distance from the end of the discharge electrode 11 is greater than 0. In addition, each plot also shows which points of FIG. 7 the distance and potential correspond to.

From this graph, it may be confirmed that as the distance from the end of the discharge electrode 11 increases, the potential decreases, that is, the gradient potential is generated.

Next, a result of confirming the dust collection performance of the charging unit 10 of Example 2 is described. Here, as the mesh electrode of the charging unit 10 of Example 2, a mesh in which the gradient potential was applied to the alumite-processed aluminum mesh having a thickness of 5 μm and a thickness of 10 μm was used. In addition, as the mesh electrode of the charging unit 320 (corresponding to the charging unit 20 of FIG. 3A) of Comparative Example 3 was used, a mesh in which the gradient potential is not applied to the aluminum mesh was used. The dust collection efficiency and ozone concentration were examined for each thickness of the charging unit 10 of Example 2 and the charging unit 320 of Comparative Example 3.

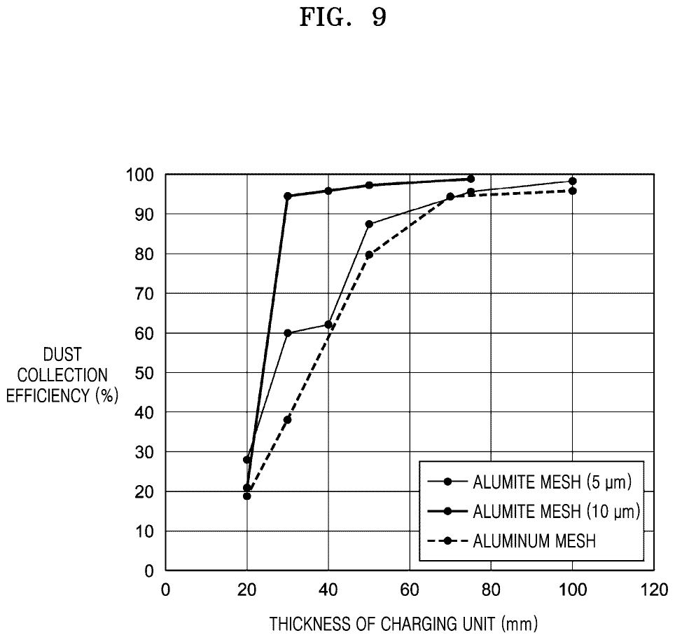

FIG. 9 is a graph showing a relationship between the thickness of the charging unit and dust collection efficiency in the charging unit of Example 2. The horizontal axis represents the thickness of the charging unit, and the vertical axis represents the dust collection efficiency. In addition, this graph shows the dust collection efficiency when a wind passes from the charging unit 10 to the dust collection unit 30 once (one pass).

From this graph, it may be confirmed that as the thickness of the charging unit increases, the dust collection efficiency increases. In addition, it may be confirmed that the dust collection rate is high in the order of the use of the alumite-processed mesh electrode having a thickness of 5 μm in the charging unit 320 of Comparative Example 3, the use of the alumite-processed mesh electrode having a thickness of 5 μm in the charging unit 10 of Example 2, and the use of the alumite-processed mesh electrode having a thickness of 10 μm in the charging unit 10 of Example 2.

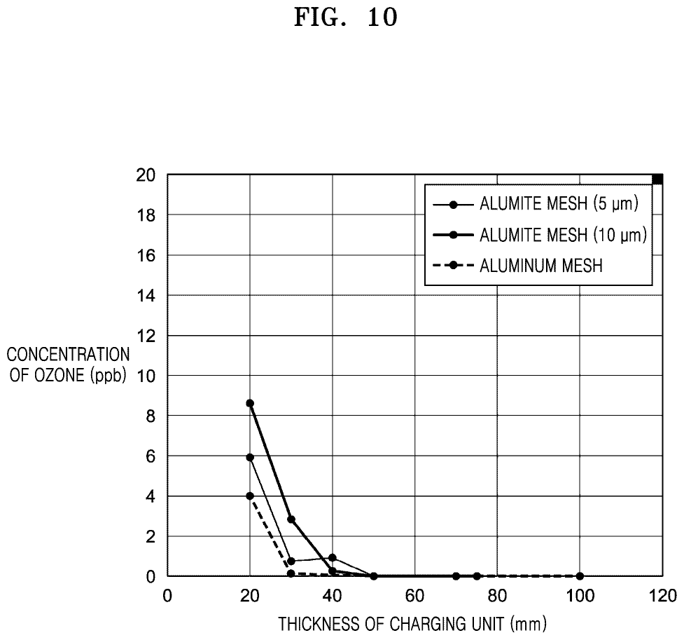

FIG. 10 is a graph showing a relationship between a thickness of the charging unit and an ozone concentration in the charging unit 10 of Example 2. The horizontal axis represents the thickness of the charging unit, and the vertical axis represents the ozone concentration.

From this graph, it may be confirmed that as the thickness of the charging unit increases, the ozone concentration decreases. In addition, it may be confirmed that the charging unit 10 of Example 2 has a higher ozone concentration than the charging unit 320 of Comparative Example 3, but the charging unit 10 using an alumite-processed mesh electrode having a thickness of 5 μm has a lower ozone concentration than the charging unit 10 using an alumite-processed mesh electrode having a thickness of 10 μm.

An electric dust collection device according to an embodiment the present disclosure may include a charging unit configured to charge airborne particulate matter, a dust collection unit configured to collect dust by attaching the particulate matter charged by the charging unit, a fan configured to generate airflow in a direction from the charging unit to the dust collection unit, and a power source configured to apply a first voltage to the charging unit, wherein the charging unit includes a discharge electrode installed approximately perpendicular to the airflow in a first direction and configured to generate ions, a ground electrode installed in a second direction to cross the airflow, and a gradient potential electrode arranged in the first direction to allow the airflow to pass therethrough and to which a second voltage lower than the first voltage is applied, wherein the second voltage gradually decreases from the discharge electrode toward a central portion of the charging unit.

In an embodiment, the gradient potential electrode may include at least one rod-shaped electrode, and the at least one rod-shaped electrode may include a first rod-shaped electrode installed approximately perpendicular to the discharge electrode when projected onto a plane perpendicular to the airflow, including the discharge electrode.

In an embodiment, the at least one rod-shaped electrode may be formed of a conductive member, and the second voltage may be determined based on a number of the at least one rod-shaped electrode.

In an embodiment, the at least one rod-shaped electrode may be formed of an anti-conductive member or an insulating member, and the second voltage may be determined based on a distance between the at least one rod-shaped electrode and the discharge electrode.

In an embodiment, the at least one rod-shaped electrode may further include a second rod-shaped electrode installed to cross the first rod-shaped electrode.

In an embodiment, the ground electrode may include a first electrode unit arranged at a position adjacent to the discharge electrode and a second electrode unit arranged at a position opposite to the discharge electrode.

In an embodiment, the first electrode unit may be formed of a rod-shaped conductive member, and the second electrode unit may be formed by a conductive member having a plate shape.

In an embodiment, the ground electrode may be formed so that the first electrode unit and the second electrode unit may approximately vertically cross each other.

In an embodiment, the discharge electrode may be formed of a plurality of fibrous conductors.

In an embodiment, the dust collection unit may include a dust collection filter.

A charging device included in an electric dust collection device, according to an embodiment of the present disclosure, may include a discharge electrode installed approximately perpendicular to airflow in a first direction and configured to generate ions, a ground electrode installed in a second direction to cross the airflow, and a gradient potential electrode arranged in the first direction to allow the airflow to pass therethrough and to which a second voltage lower than the first voltage is applied, wherein the second voltage gradually decreases from the discharge electrode toward a central portion of the charging unit.

In an embodiment, the gradient potential electrode may include at least one rod-shaped electrode, and the at least one rod-shaped electrode may include a first rod-shaped electrode installed approximately perpendicular to the discharge electrode when projected onto a plane perpendicular to the airflow, including the discharge electrode.

In an embodiment, the at least one rod-shaped electrode may be formed of a conductive member, and the second voltage may be determined based on a number of the at least one rod-shaped electrode.

In an embodiment, the at least one rod-shaped electrode may be formed of an anti-conductive member or an insulating member, and the second voltage may be determined based on a distance between the at least one rod-shaped electrode and the discharge electrode.

In an embodiment, the at least one rod-shaped electrode may further include a second rod-shaped electrode installed to cross the first rod-shaped electrode.

### CONCLUSION

According to the present disclosure, the charging space may be uniformly charged by widely transporting ions generated by the discharge electrode.

In the present embodiment, the gradient potential electrodes 13a and 13b to which the gradient potential is applied are provided. This enables the ions generated by the discharge electrode 11 to be widely transported, and thus, the charging space may be uniformly charged.

In addition, in the present embodiment, the gradient potential is applied to the gradient potential electrodes 13a and 13b, or a material that provides the gradient potential effect is selected as materials of the gradient potential electrodes 13a and 13b. This makes it possible to suppress charging due to electric charge accumulation in the surrounding members, such as the charging member, the pre-filter, and the dust collection unit.

In addition, in the present embodiment, field concentration is alleviated. As a result, the amount of ozone generated is suppressed, and thus, spark discharge hardly occurs.

### LIST OF REFERENCE NUMERALS FOR MAJOR ELEMENTS

1 . . . electric dust collection device, 10 . . . charging unit, 11 . . . discharge electrode, 12 . . . ground electrode, 13a, 13b . . . gradient potential electrode, 14 . . . power supply member, 30 . . . dust collection unit, 40 . . . fan, 50 . . . case, 60 . . . high voltage power source

1. An electric dust collection device comprising:
a charging unit configured to charge airborne particulate matter;
a dust collection unit configured to collect dust by attaching the particulate matter charged by the charging unit;
a fan configured to generate airflow in a direction from the charging unit to the dust collection unit; and
a power source configured to apply a first voltage to the charging unit,
wherein the charging unit includes:
a discharge electrode arranged so as to be approximately perpendicular to the airflow in a first direction and configured to generate ions,
a ground electrode arranged so as to be in a second direction to cross the airflow, and
a gradient potential electrode arranged so as to be in the first direction to allow the airflow to pass therethrough and to which a second voltage lower than the first voltage and that gradually decreases from the discharge electrode toward a central portion of the charging unit is applicable.

2. The electric dust collection device of claim 1, wherein
the gradient potential electrode includes at least one rod-shaped electrode, and
the at least one rod-shaped electrode includes a first rod-shaped electrode arranged so as to be approximately perpendicular to the discharge electrode when projected onto a plane perpendicular to the airflow, including the discharge electrode.

3. The electric dust collection device of claim 2, wherein
the at least one rod-shaped electrode is formed of a conductive member, and
the second voltage is based on a number of the at least one rod-shaped electrode.

4. The electric dust collection device of claim 2, wherein
the at least one rod-shaped electrode is formed of an anti-conductive member or an insulating member, and
the second voltage is based on a distance between the at least one rod-shaped electrode and the discharge electrode.

5. The electric dust collection device of claim 2, wherein the at least one rod-shaped electrode further includes a second rod-shaped electrode arranged so as to cross the first rod-shaped electrode.

6. The electric dust collection device of claim 1, wherein the ground electrode includes:
a first electrode unit arranged so as to be at a position adjacent to the discharge electrode, and
a second electrode unit arranged so as to be at a position opposite to the discharge electrode.

7. The electric dust collection device of claim 6, wherein
the first electrode unit is formed of a rod-shaped conductive member, and
the second electrode unit is formed by a conductive member having a plate shape.

8. The electric dust collection device of claim 6, wherein the ground electrode is formed so that the first electrode unit and the second electrode unit approximately vertically cross each other.

9. The electric dust collection device of claim 1, wherein the discharge electrode is formed of a plurality of fibrous conductors.

10. The electric dust collection device of claim 1, wherein the dust collection unit includes a dust collection filter.

11. A charging unit configured to charge airborne particulate matter and arrangeable in an electric dust collection device that includes a dust collection unit configured to collect dust by attaching the particulate matter charged by the charging unit, a fan configured to generate airflow in a direction from the charging unit to the dust collection unit, and a power source configured to apply a first voltage to the charging unit, the charging unit comprising:
a discharge electrode arranged so as to be approximately perpendicular to the airflow in a first direction and configured to generate ions;
a ground electrode arranged so as to be in a second direction to cross the airflow; and
a gradient potential electrode arranged so as to be in the first direction to allow the airflow to pass therethrough and to which a second voltage lower than the first voltage and that gradually decreases from the discharge electrode toward a central portion of the charging unit is applicable.

12. The charging unit of claim 10, wherein
the gradient potential electrode includes at least one rod-shaped electrode, and
the at least one rod-shaped electrode includes a first rod-shaped electrode arranged so as to be approximately perpendicular to the discharge electrode when projected onto a plane perpendicular to the airflow, including the discharge electrode.

13. The charging unit of claim 12, wherein
the at least one rod-shaped electrode is formed of a conductive member, and
the second voltage is based on a number of the at least one rod-shaped electrode.

14. The charging unit of claim 12, wherein
the at least one rod-shaped electrode is formed of an anti-conductive member or an insulating member, and
the second voltage is based on a distance between the at least one rod-shaped electrode and the discharge electrode.

15. The charging unit of claim 12, wherein the at least one rod-shaped electrode further includes a second rod-shaped electrode arranged so as to cross the first rod-shaped electrode.
